(19) United States
(12) Patent Application Publication
(10) Pub. No.: US 2012/0310711 A1
(43) Pub. Date: Dec. 6, 2012

(54) SYSTEM USING FEEDBACK COMMENTS LINKED TO PERFORMANCE DOCUMENT CONTENT

(75) Inventors: Nancy V. Lang, Palatine, IL (US); Yumiko Christine Yokoi, San Francisco, CA (US); Steven K. Chu, San Ramon, CA (US); Andrew Philip Gillibrand, Berkshire (GB); Chau Ha Leung, Castro Valley, CA (US)

(73) Assignee: Oracle International Corporation, Redwood Shores, CA (US)

(21) Appl. No.: 13/149,593

(22) Filed: May 31, 2011

(51) Int. Cl. G06Q 10/00

(52) U.S. Cl. 705/7.42

(57) ABSTRACT

A system and method for facilitating controlling locations or associations of displayed content in a user interface. An example method includes displaying a first type of information; providing a first user option to select a portion of the first type of information; providing a second user option to associate selected information with one or more information categories; and displaying an instance of the selected information in association with the one or more information categories. In a specific embodiment, the user interface displays content pertaining to a performance evaluation document, which is associated with one or more enterprise employees. The first type of information includes feedback comments associated with a performance of the one or more enterprise employees.

### CROSS REFERENCES TO RELATED APPLICATIONS

This application is related to the following application, U.S. patent application Ser. No. 13/114,596, entitled SYSTEM PROVIDING AUTOMATED FEEDBACK REMINDERS, filed on May 24, 2011, Attorney Docket No. ORACP0044 (ORA110293-US-NP), which is hereby incorporated by reference, as if set forth in full in this specification for all purposes.

This application is further related to the following application, U.S. patent application Ser. No. ______, entitled PERFORMANCE MANAGEMENT SYSTEM USING UNSOLICITED FEEDBACK filed on May 31, 2011, Attorney Docket No. ORACP0046 (ORA110295-US-NP), which is hereby incorporated by reference, as if set forth in full in this specification for all purposes.

### BACKGROUND

The present application relates to software and more specifically to electronically stored documents, such as employee performance review documents, and accompanying user interfaces and methods for selectively accessing and organizing information therein.

Methods for selectively accessing and organizing information are particularly important in enterprise performance review applications and accompanying documents, where the review process pertaining to a given enterprise employee may include collecting multiple types of information from different sources to facilitate rating an employee's work performance. A streamlined performance review process can help enterprises make informed human resources decisions, which may impact overall enterprise productivity and goal attainment.

Enterprises may conduct periodic performance evaluations of employees and managers. In an example scenario, a manager is tasked with reviewing and rating the performance of subordinate employees. When rating a given employee, the manager may use multiple instances of feedback from other employees, mentors, or other enterprise personnel who have worked with the employee.

Feedback collected from enterprise personnel may be displayed in different locations within an enterprise performance review document for a given employee, and these locations may be disjoint from relevant competencies, goals, and so on, associated with each instance of feedback. When performing an employee evaluation, a manager may wish to first review associated employee feedback. However, when rating competencies, goals, or other performance factors, the manager may be tasked with remembering feedback seen in a different portion of the performance review document.

Alternatively, the manager may manually collect and then print the feedback. The manager can then refer to the printed feedback when determining employee performance ratings. However, such manual sorting and/or printing of feedback within a document can be undesirably time consuming.

### SUMMARY

An example method for facilitating controlling locations of displayed content in a user interface includes displaying a first type of information (such as feedback); providing a first user option to select a portion of the first type of information; providing a second user option to associate selected information with one or more information categories; and displaying an instance of the selected information in association with the one or more information categories.

In a specific embodiment, the user interface displays content pertaining to a performance evaluation document, which is associated with one or more enterprise employees. The first type of information includes feedback associated with a performance of the one or more enterprise employees. An instance of the first type of information includes a feedback message or portion thereof.

The user interface display screen for displaying the first type of information displays one or more instances of feedback provided by one or more enterprise personnel. The first user option is implemented via a user interface control that is displayed in proximity to the one or more instances of feedback. The user interface control may be implemented via a button or icon that is responsive to user selection thereof to display the second user option.

The second user option may be implemented via a dialog box or window with user interface controls for enabling a user select the one or more information categories to be associated with a selected instance of feedback or portion thereof. Another user option enables user selection of a portion of the one or more instances of feedback, after which user interface controls of the dialog box or window may be employed to associate the selected portion with a predetermined information category or sub-category.

Note that a sub-category is considered to be a type of information category. Examples of information categories include employee competency, employee goals, and so on. Information categories may further include sub-categories. For example, the competency category may include teamwork, leadership, problem solving, presentation skills, communication, decision making, and so on.

The present example method involves enabling users to associate feedback information in a performance review document with different categories or sections accessible via the document. The performance review document may be a HyperText Markup Language (HTML), eXtensible Markup Language (XML) document, and/or other document.

The step of displaying a first type of information may includes displaying a first user interface display section, which displays contents of answers from a questionnaire pertaining to an enterprise person associated with a performance review document. A second user interface display section, such as a competency section or goal section, corresponds to a particular information category. Different sections of the performance review document may be accessible via tabs or other user interface mechanisms.

The novel design of certain embodiments disclosed herein is facilitated by mechanisms for enabling the linking of and/or the dispatch of instances of selected information, such as feedback, to relevant sections or information categories within a document, such as a performance review document. Hence, certain embodiments disclosed herein may facilitate expediting employee evaluations and may further facilitate construction of more accurate employee evaluations, since relevant supporting information may become more readily available or visible.

Expediting and improving the employee evaluation process conducted by a manager may enable increased manager productivity. Furthermore, managers may have a clearer understanding of subordinate employee strengths and weaknesses, thereby facilitating important talent management decisions.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a block diagram of an example system for implementing selective feedback linking within a performance document.

FIG. 2 illustrates a first user interface display screen depicting a portion of a performance document listing feedback associated with an enterprise employee.

FIG. 3 illustrates an example dialog box or window with user interface controls for facilitating linking or organizing particular feedback within a performance document, wherein the window appears in response to selection of a tag button adjacent to a feedback message.

FIG. 4 is illustrates a second user interface display screen, which shows feedback messages or portions thereof that have been associated with a particular competency with the performance document.

FIG. 5 is a flow diagram of first example method adapted for use with the embodiments of FIGS. 1-4.

FIG. 6 is a flow diagram of a second example method adapted for use with the embodiments of FIGS. 1-4.

### DETAILED DESCRIPTION OF EMBODIMENTS

Although the description has been described with respect to particular embodiments thereof, these particular embodiments are merely illustrative, and not restrictive.

For example, while the present application is discussed with respect to methods and accompanying user interfaces for selectively associating feedback in a performance evaluation document with information categories, such as competencies and goals, which correspond to user interface sections or tabs used to display document content, embodiments are not limited thereto. For example, any document or user interface may benefit by methods for selectively associating, linking, or otherwise facilitating copying portions of desired content to other sections of a document or user interface in accordance with embodiment disclosed herein.

Furthermore, while embodiments are discussed herein with respect to an enterprise application pertaining to performance management, embodiments are not limited thereto. For example, content organization and linking methods discussed herein may be employed in various applications other than enterprise applications, where improved ability to organize content in a document or user interface is desired.

For the purposes of the present discussion, an enterprise may be any organization of persons, such as a business, university, government, military, and so on. The terms “organization” and “enterprise” are employed interchangeably herein. Personnel of an organization or enterprise, i.e., enterprise personnel, may include any persons associated with the organization, such as employees, contractors, board members, and so on. The terms “employee” or “employees” and “enterprise personnel” are employed interchangeably herein. For example, an enterprise employee, or simply employee, may be any person associated with an organization, such as a worker, manager, executive, contractor, or other person who may be subject to being rated via a performance document.

For the purposes of the present discussion, a document may be any collection of information, which may include one or more virtual files (as opposed to a printed hard copy of a file) and/or computing objects. A document need not be represented as a single file, but may include, for example, files linked together and accessible via a common interface, such as via an HyperText Markup Language (HTML) web page or file. A performance review document, also called a performance evaluation document, may be any document adapted to specifically contain or reference information pertaining to the performance and/or behavior of an employee or other enterprise personal over a predetermined time interval.

An information category may be any grouping of information identified by a label applied to the information. Generally, information categories discussed herein, such as competencies, goals, and so on corresponds to information about competencies, goals, and so on. Each information category may include sub-categories. For example, a competency category may include information pertaining to an employee's competency as it applies to leadership, teamwork, problem solving, presentation, decision making, communication skills, and so on. Leadership, teamwork, and so on, may represent sub-categories of the competency category.

For the purposes of the present discussion, feedback is considered to be a type of information, which includes any information or input regarding the performance of one or more tasks, behavior, and so on. Feedback may include, for example, advice given to a person (e.g., employee) pertaining to a particular task, comments pertaining to a particular competency, input pertaining to tasks associated with a certain goal, advice pertaining to future or past performance, goals, aspirations, and so on. A feedback message may be any message, such as an electronic message, that includes feedback information.

An electronic message may be any communication sent or stored electronically, such as via a computer. A communication may be any portion of information, such as a note, document, and so on. Examples of electronic messages include emails and/or associated attachments or portions thereof, text messages, instant messages sent via Internet Relay Chat (IRC), and so on.

For clarity, certain well-known components, such as hard drives, processors, operating systems, power supplies, and so on, have been omitted from the figures. However, those skilled in the art with access to the present teachings will know which components to implement and how to implement them to meet the needs of a given application.

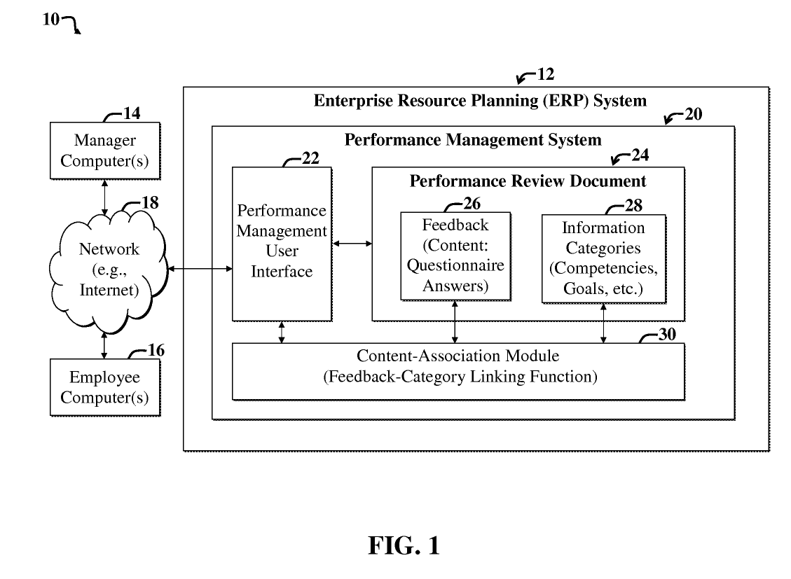

FIG. 1 is a block diagram of an example system 10 for implementing selective feedback linking within a performance review document 24, also called an employee performance evaluation document.

The example system 10 includes an Enterprise Resource Planning (ERP) system 12 in communication with a manager computer 14 and an employee computer 16 via a network 18. For illustrative purposes, only the manager computer 16 and employee computer 16 are shown as client computers coupled to the network 18. However, note that various enterprise personnel may have client computers that can access the ERP system 12 via the network 18.

For the purposes of the present discussion, an ERP system may be any infrastructure, i.e., resources, such as hardware and ERP software, used to facilitate managing resources of an organization. ERP software may be any set of computer code that is adapted to facilitate managing resources of an organization. Example resources include Human Resources (HR), financial resources, assets, employees, and so on, of an enterprise. The terms “ERP software” and “ERP application” may be employed interchangeably herein. However, an ERP application may include one or more ERP software modules or components, such as user interface software modules or components.

The ERP system 12 further includes a performance management system 20, which includes a performance management user interface 22, which may include Graphical User Interface (GUI) software for facilitating interfacing the manager computer 14 and the employee computer 16 to the ERP system 12. Note that the performance management user interface software 22 may be implemented via client-side code (e.g., implemented in the client computers 14, 16) as opposed to server-side computer code (e.g., implemented on an ERP server system 12) without departing from the scope of the present teachings.

In general, various modules of the system 10 of FIG. 1 may be implemented in one or more computers and/or networks, and modules may be combined or repositioned. For example, a content-association module 30 running on the performance management system 20 may be implemented on the manager computer 14 and the employee computer 16.

The performance management user interface 22 facilitates interfacing the client computers 14, 16 with a performance review document 24 and a content-association module 30 running on the performance management system 20. The performance review document 24 includes feedback content 26, which may include questionnaires and accompanying answers to questions provided thereby. Content of the performance review document 24 may include content that is partitioned into one or more information categories 28. The content-association module 30 communicates with the performance management user interface 22, and the feedback 26 and information categories or sections 28, of the performance review document 24.

The content-association module 30 includes computer code for facilitating enabling a user of the performance management user interface 22 to assign or link instances of the feedback 26 to one or more information categories 28, as discussed more fully below.

In an example operative scenario, a manager employing the manager computer 14 is to finalize a performance evaluation document 24, which provides an evaluation of past performance of an employee who is using the employee computer 16. Various feedback that the employee 16 has received from the manager or other enterprise personnel responding to feedback questionnaires is lodged in the performance review document as feedback 26.

Note that while the feedback 26 includes answers culled from questionnaires, the feedback 26 is not limited thereto. For example the feedback 26 may be populated from email messages exchanged between various enterprise personnel in accordance with the above-identified U.S. patent application Ser. No. ______, entitled PERFORMANCE MANAGEMENT SYSTEM USING UNSOLICITED FEEDBACK, filed on ______, Attorney Docket No. ORACP0046-ORA110295-US-NP, which is entirely incorporated by reference herein.

The manager employs the manager computer 14 to log into the performance management system 20 via the network 18 and performance management user interface 22. The manager then employs the performance management user interface 22 to open the performance review document 24 pertaining to the employee.

In the present example embodiment, the content-association module 30 includes code for generating buttons or other user interface controls, which are displayed adjacent to instances of feedback 26 to the logged-in manager via the performance management user interface 22. The manager may select the button adjacent to a particular instance of feedback, e.g., an answer to a question of a questionnaire (or selected portion thereof), to trigger display of additional user interface controls for assigning the instance of feedback to a particular information category.

Code running on the content-association module 30 determines which instance of feedback the manager has chosen to assign to which information category and then inserts the instance of feedback into the section of the performance review document 24 corresponding to the selected information category. Alternatively, or in addition, one or more links are provided in each section of the document 28 that is used to display information pertaining to an information category that has been associated with the instance of feedback.

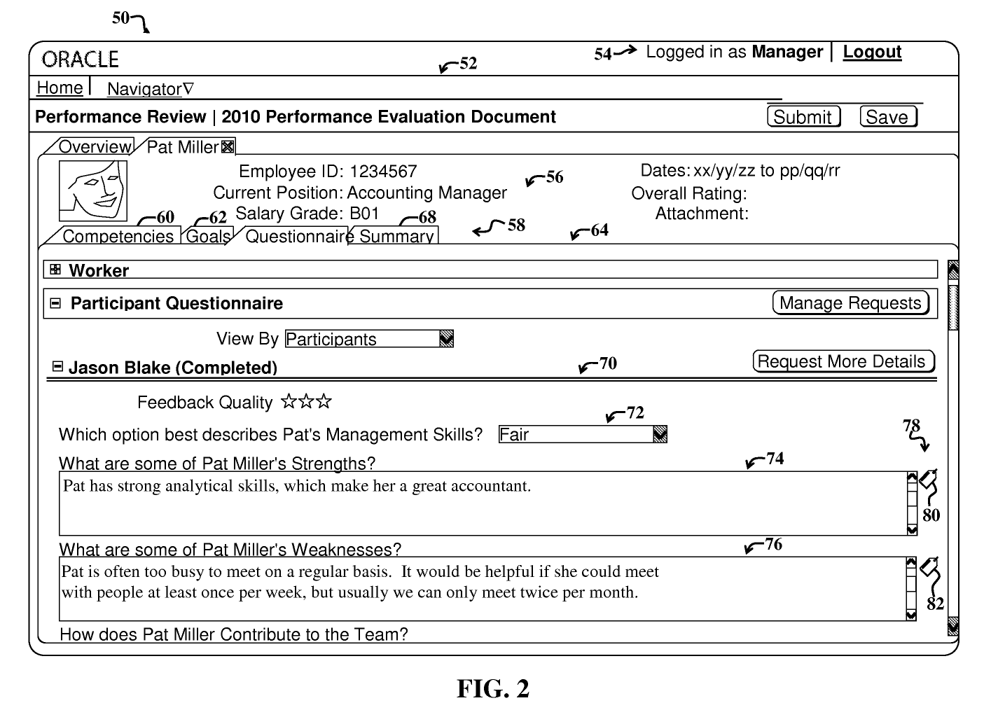

FIG. 2 illustrates a first user interface display screen depicting a portion of a performance document 52 displaying feedback messages 74, 76 in a feedback questionnaire section 70 completed by a co-worker (James Blake) of an enterprise employee (Pat Miller) to which the feedback pertains, i.e., is associated with. Note that while only feedback provided by Jason Blake is shown, feedback from other personnel, such as the manager, may be provided via the user interface display screen 50.

The feedback section 70 is part of a questionnaire provided via questionnaire section 64. The questionnaire section 64 is accessible via tabs 58, which include a competencies tab 60, a goals tab 62, and a summary tab 68. The various tabs 58 correspond to sections of the user interface display screen 50 pertaining to a performance evaluation document for evaluating the performance of an enterprise employee, who in this example scenario, is Pat Miller. Identification information 56 pertaining to Pat Miller is displayed above the tabs 58.

The competencies tab 60 and goals tab 62 corresponding to user interface sections, which correspond to information categories, as discussed more fully below. Each of the feedback messages 74, 76 may be associated with various information categories 60, 62 after user selection of adjacent user interface controls 78, which include a first button 80 shown in association with, i.e., adjacent to, a first feedback message 74, and a second button 82 shown in association with, i.e., adjacent to, a second feedback message 76.

A ratings drop-down menu 72 provides user options for rating the subject employee (Pat Miller). In the present example operative scenario, the Jason Blake has rated Pat Miller's management skills as fair.

In the present operative scenario, the performance evaluation document 52 is being reviewed by a manager, as indicated via a login information section 54. If the manager decides, for example, that the first feedback message 74 represents competency feedback, then the manager may select the associated button 80 to activate additional user interface controls to enable the manager to assign the feedback message 74 to one or more competency information categories. Once the first feedback message 74 is assigned to one or more information categories, such as a competency category, then the feedback corresponding to the first feedback message 74 will appear in a user interface section accessible via the competencies tab 60.

In a second example operative scenario, the manager selects a portion of the second feedback message 76, such as by highlighting a portion of the message 76 via a mouse cursor. After highlighting a desired portion of the message and selecting the adjacent button 82, additional user interface controls appear (e.g., via a dialog box or window) that enable the manager to designate, i.e., assign the selected portion of the second feedback message 76 to one or more desired information categories. The selected portion(s) of the second feedback message 76 will then be viewable via one or more sections of the document 52, which are accessible via the tabs 60, 62 or sub-tabs thereof. The one or more sections of the document 52 correspond to the information categories to which the selected portion(s) of the second feedback message 76 have been assigned or designated.

Note that a feedback message, such as the first feedback message 74 or second feedback message 76 may represent instances of feedback. Furthermore, selected portions of the messages 74, 76 also represent instances of feedback. Instances of feedback are also simply called feedback herein.

In the present specific embodiment, instances of feedback, which have been assigned to one or more information categories are copied or dispatched to user interface sections corresponding to the information categories. However, alternative implementations are possible. For example, instead of selectively copying instances of feedback to different locations of the document 52, links (e.g., HTML links) to the instances of feedback may appear in the different locations, i.e., sections corresponding to different information categories.

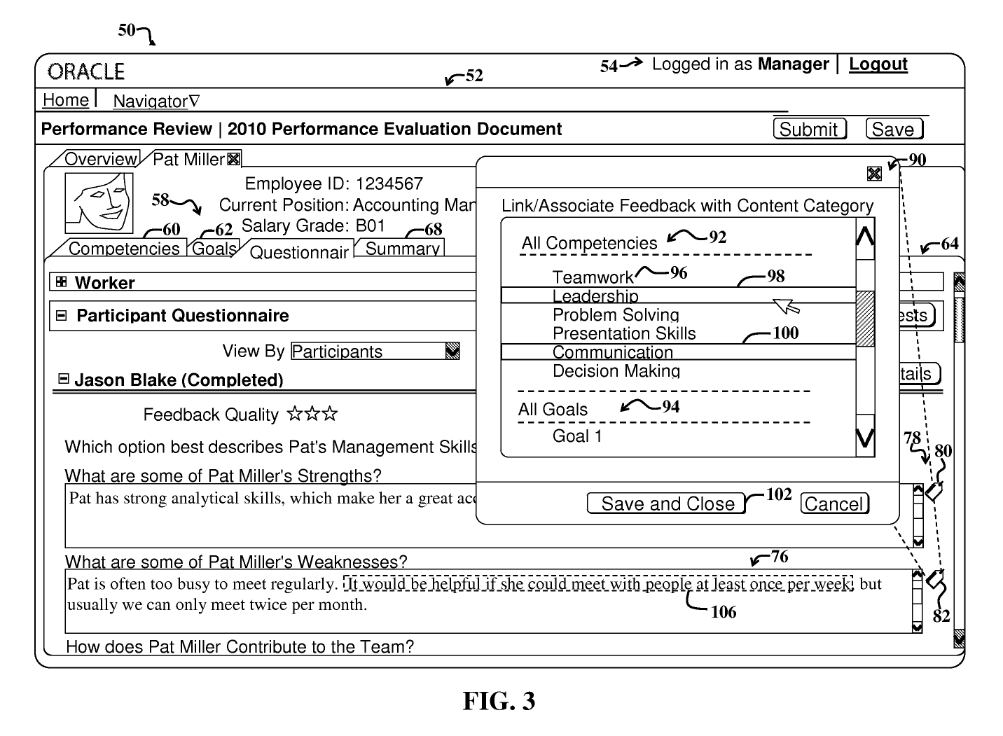

FIG. 3 illustrates an example dialog box or window 90 with various user interface controls 92-104 for facilitating linking or organizing particular feedback within a performance document. The dialog box 90 appears in response to selection of the second tag button 82, which is adjacent to the second feedback message 76. For the purposes of the present discussion, a dialog box may be any computer-generated graphical representation that includes one or more displayed mechanisms that are responsive to user input.

The example dialog box 90 includes various user interface controls, including a selectable competencies category 92 with selectable competency sub-categories 96-100 associated therewith. In addition, a selectable goals category 94 includes an example selectable goals subcategory (goal 1).

In operation, a user, such as a manager, may select one or more of the categories and/or sub-categories 92-100. In the present example operative scenario, a manager has first selected (e.g., by highlighting) a portion of feedback 106 from the second feedback message 76. After selecting the portion of feedback 106, the manager selects the adjacent second tag button 82 to activate the dialog box 90. The manager has then selected a leadership category 98 and a communication category 100, which are sub-categories of the competency category 92, to which to assign or designate the selected portion of feedback 106. Note that one or more competencies and/or one or more goals may be simultaneously selected.

After selecting the leadership category 98 and communication category 100 and activating a save and close button 102, the selected portion of feedback 106 will be visible or otherwise available via leadership and communication sub-sections of a competency section, as discussed more fully below. The competency section corresponds to, i.e., is accessible via, the competencies tab 60.

If the manager had not selected (e.g., by highlighting) the portion of feedback 106 prior to selection of the second tag button 82, then the entire contents of the feedback message 76 would be allocated, assigned, designated, copied to, or otherwise made available to users via one or more different sections of the document 52. The one or more different sections 60-64, 68 of the document 52 are identified via section headers in the dialog box 90. Note that the selected user interface controls 98, 100 correspond to information sub-categories and associated section(s), such as a competency section, which is accessible via the competencies tab 60. In general, feedback is linked to or associated with a particular information sub-category.

Hence, the dialog box 90 may display to the manager a list of all of the competencies and goals within a particular employee's performance evaluation document. The manager can then select the appropriate competency or goal to associate with highlighted feedback. For example, a feedback comment could be: “This employee worked very well with everyone on the team.” The manager can highlight this sentence and link it to the ‘Teamwork’ competency. When the manager is in the process of rating the competencies and goals, they will see the linked feedback next to each competency or goal. The manager will no longer have to print a hardcopy of the feedback, since the information will be readily accessible to them on the screen.

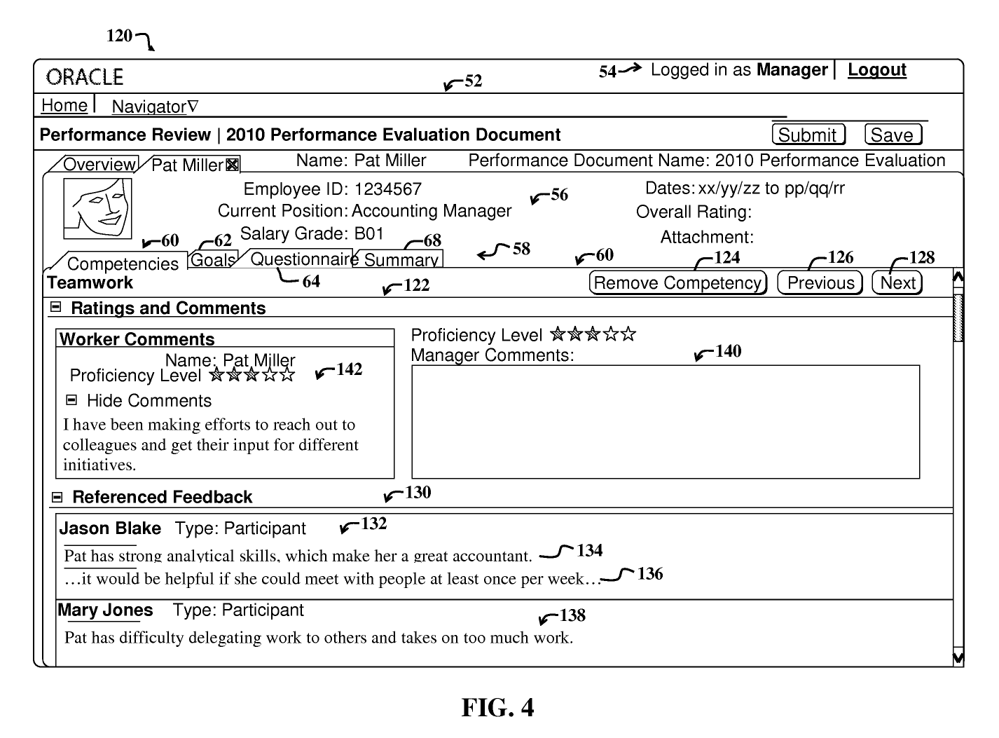

FIG. 4 is illustrates a second user interface display screen 120, which shows feedback messages 132, 138 or portions thereof that have been associated with a particular competency with the performance document 52.

The example user interface display screen 120 illustrates example contents of the competencies tab 60 section of the performance evaluation document 52. The example competencies tab 60 illustrates a teamwork section 122, which represents a teamwork subcategory, which represents a particular competency. Other competencies, such as leadership, communication, and so on, may be accessed via selective user manipulation of a previous button 126 and a next button 128. A particular competency, e.g., teamwork, may be deleted from the competencies tab 60 via user selection of a remove-competencies button 124.

The example teamwork competency section 122 includes worker comments 142 (which are provided by the employee being evaluated via the performance evaluation document 52), a field for manager comments 140, and a referenced feedback section 130. The referenced feedback section 130 illustrates a first example set of feedback 132 from Jason Blake pertaining to Pat Miller, and a second instance of example feedback 138 by Mary Jones. The example feedback 132 entered by James Black includes instances 134, 136 of feedback messages or portions thereof, which were assigned to the competencies tab 60 (i.e., information category) via a manager employing various user interface controls 80, 82, 90-102 of FIG. 3.

Hence, by using one or more embodiments discussed herein, a manager may now readily and easily link feedback or portions thereof to the relevant employee competencies and goals. As the manager is reviewing feedback comments, they can highlight all or part of a particular feedback text and then click on a button or other user interface control to activate functionality for linking the highlighted, i.e., selected, feedback to a competency or goal in the performance document.

Certain embodiments disclosed herein provide an easy and convenient way to organize feedback to support a particular rating that is given for each competency and goal in a performance evaluation document. The relevant feedback will be conveniently available to the user in select user interface locations, thereby obviating the need for the manager to remember feedback seen elsewhere; to navigate to another are of the performance document; or to print feedback. Hence, embodiments disclosed herein may help expedite the performance evaluation process and may help rating employees, since supporting information may now be more readily available or visible.

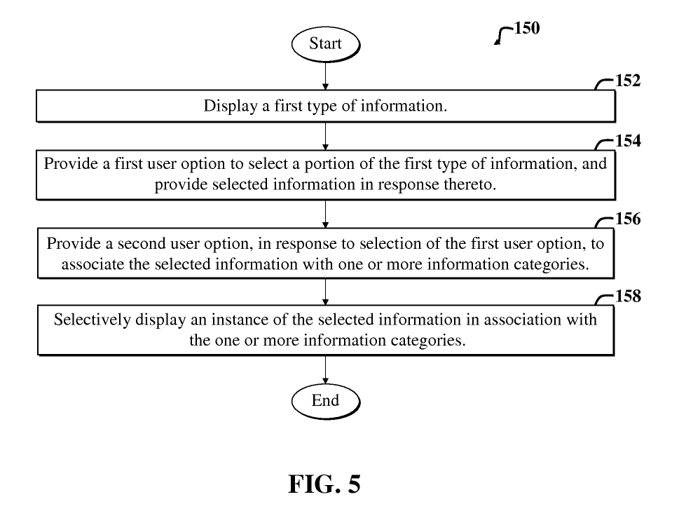

FIG. 5 is a flow diagram of first example method 150 adapted for use with the embodiments of FIGS. 1-4. The example method 150 is adapted to facilitate controlling locations of displayed content, such as feedback, in a user interface.

The example method 150 includes a first step 152, which involves displaying a first type of information, e.g., feedback.

A second step 154 includes providing a first user option to select a portion of the first type of information, and providing selected information in response thereto, such as to the content-association module 30 of FIG. 1.

A third step 156 includes providing a second user option, in response to selection of the first user option, to associate the selected information with one or more information categories. The second user option may be implemented, for example, via the dialog box 90 of FIG. 3.

A fourth step 158 includes selectively displaying an instance of the selected information, such as via the referenced feedback section 130 of FIG. 4, in association with the one or more information categories, such as a competency or goal category or sub-category thereof.

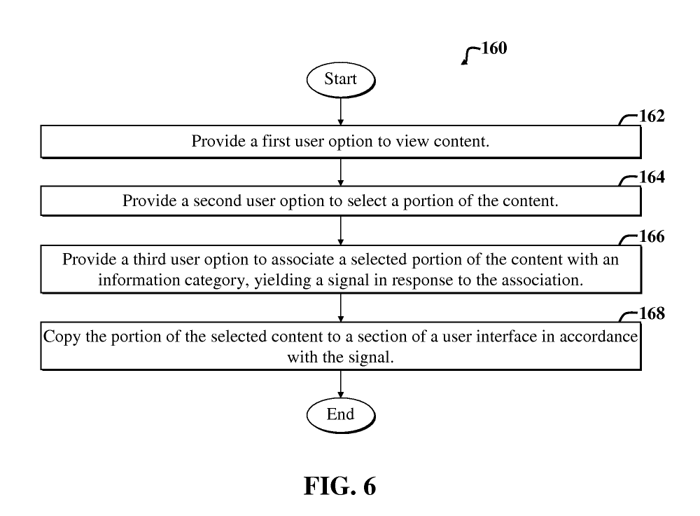

FIG. 6 is a flow diagram of a second example method 160 adapted for use with the embodiments of FIGS. 1-4. The second example method 160 is adapted to facilitate assisting a user, such as a manager, in assigning content, such as feedback, to a content category, such as a competency or goal category (or sub-category thereof), to be displayed via a user interface.

The second example method 160 includes an initial step 162, which involves providing a first user option to view content, such as feedback.

A subsequent selection step 164 includes providing a second user option to select a portion of the content.

A subsequent association step 166 includes providing a third user option to associate a selected portion of the content with an information category, yielding a signal in response to the association.

A final copying step 168 includes copying or otherwise linking the portion of the selected content to a section (e.g., a competency or goal section or sub-section thereof) of a user interface in accordance with the signal.

Note that various steps of the methods 150, 160 of FIGS. 5 and 6 may be omitted, rearranged, or steps may be added without departing from the scope of the present teachings. For example, the method 160 may further include or specify that the viewed content comprises feedback given in an enterprise environment, e.g., via an ERP system or computers coupled thereto.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A method for controlling association of displayed feedback comments to performance review content in a user interface rendered on a graphical user interface using a computer, the method comprising:
displaying a first type of information in the graphical user interface;
rendering in the graphical user interface a first user option to select a subset of the first type of information;
providing a visually perceivable stimuli on the graphical user interface of a second user option to associate the subset with an information category in a performance review document; and
creating, on the graphical user interface, a representation of an association between the subset and the category.

2. The method of claim 1, wherein providing further includes concurrently rendering upon the graphical user interface the subset and the second user option.

3. The method of claim 1, wherein rendering further includes concurrently rendering upon the graphical user interface the subset and the first user option.

4. The method of claim 1, wherein displaying the first type of information further includes providing a user interface display screen that is adapted to display one or more instances of feedback provided by one or more enterprise personnel.

5. The method of claim 1, wherein rendering further includes displaying the first user option in proximity to the one or more instances of feedback.

6. The method of claim 1, wherein rendering further includes concurrently rendering upon the graphical user interface the subset and the first user option and providing further includes concurrently rendering upon the graphical user interface the subset and the second user option and the first user option.

7. The method of claim 6, wherein providing the second user option includes displaying a dialog box or window to enable a user select the one or more information categories to be associated with a selected instance of feedback or portion thereof.

8. The method of claim 1, wherein the subset of the first type of information includes all of the first type of information.

9. The method of claim 5, wherein the information category includes a competency category.

10. The method of claim 9, wherein the competency category includes a selectable teamwork competency sub-category of the competency category.

11. The method of claim 9, wherein the competency category includes a selectable leader ship competency sub-category of the competency category.

12. The method of claim 5, wherein the information category includes a goals category.

13. The method of claim 1, wherein the content in a user interface includes content comprising a performance review document.

14. The method of claim 13, wherein the performance review document includes a HyperText Markup Language (HTML) or eXtensible Markup Language (XML) document.

15. The method of claim 13, wherein the first type of information includes feedback pertaining to an employee or other person of an enterprise.

16. The method of claim 13, wherein displaying a first type of information includes displaying a first user interface display section that includes a display of contents of answers from a questionnaire pertaining to an enterprise person associated with a performance review document.

17. The method of claim 16, wherein creating includes providing a second user interface display section, whereby a particular category of the one or more information categories is displayed.

18. (canceled)

19. An apparatus comprising:
a digital processor coupled to a display and to a processor-readable storage device, wherein the processor-readable storage device includes one or more instructions executable by the digital processor to perform the following functions:
displaying a first type of information in the display;
rendering in the display a first user option to select a subset of the first type of information;
providing a visually perceivable stimuli on the display of a second user option to associate the selected information subset with an information category in a performance review document, with said visually perceivable stimuli being present on the display concurrently with the subset; and
creating, on the display, a representation of an association between the subset and the category.

20. A processor-readable storage device including instructions executable by a digital processor, the processor-readable storage device including one or more instructions for:
displaying a first type of information in the graphical user interface;
rendering in the graphical user interface a first user option to select a subset of the first type of information;
providing a visually perceivable stimuli on the graphical user interface of a second user option to associate the subset with an information category in a performance review document with the visually perceivable stimuli being present on the display concurrently with the subset; and
creating, on the graphical user interface, a representation of an association between the subset and the category.
